(19) United States
(12) Patent Application Publication
(10) Pub. No.: US 2008/0217464 A1
(43) Pub. Date: Sep. 11, 2008

(54) PACKAGING DEVICES AND METHODS OF PRODUCING SAME

(76) Inventors: Lawrence M. Ridgeway, Charleston, SC (US); James M. Lee, Florence, SC (US)

Correspondence Address: B. CRAIG KILLOUGH, P. O. DRAWER H, CHARLESTON, SC, 29402, US

(21) Appl. No.: 12/119,225

(22) Filed: May 12, 2008

Related U.S. Application Data
(63) Continuation-in-part of application No. 10/654,295, filed on Sep. 3, 2003.
Application No. 10/654,295 is a continuation of application No. 10/042,687, filed on Aug. 21, 2001, now Pat. No. 7,370,827.
Application No. 10/042,687 is a continuation of application No. 09/383,908, filed on Aug. 26, 1999, now Pat. No. 6,341,745.

(51) Int. Cl. B65H 75/18; B65H 75/14; B31B 1/60

(52) U.S. Cl. 242/608; 242/600; 493/84

(57) ABSTRACT

A packaging device has a core that is connected to a sheet of material by a flowable material that sets or cures to harden, such as a two part expandable polyurethane foam. The sheet of material has a plurality of cells that the flowable material enters from a partition that forms the core through an aperture or apertures formed in the sheet of material. The chemistry of the flowable material may be altered to change density, rigidity and flexibility as required by package stresses. The flowable material is effective at creating a durable attachment of the core and sheet of material for forming packaging materials such as reels.

This application is a continuation-in-part of application Ser. No. 10/654,295 filed Sep. 3, 2003, which application is a continuation of application Ser. No. 10/042,687, having an effective filing date of Aug. 26, 1999, which is a continuation of application Ser. No. 09/383,908, filed Aug. 26, 1999, U.S. Pat. No. 6,341,745. Applicant claims priority pursuant to these applications.

### FIELD OF THE INVENTION

This invention relates to packaging materials generally, and is more specifically related to packaging materials formed using flowable material that joins parts.

### BACKGROUND OF THE INVENTION

Reel packages and spool packages are used for the packaging of products which are produced in a continuous and connected manner and are packaged in large number or high count continuous lengths for long run use, including automated use. These products may be packaged in a “ribbon wound” (layer on layer) or convolute manner on a central reel core, or traversed on the reel, so that the user of the product may unwind the product in an orderly, controlled manner for use or installation in other products. Products which are packaged on reels and spools are made of a wide variety of raw materials including metals, plastics, textiles and other products. Packages for these products have sidewalls or flanges which act as retainers to keep the product from slipping off and becoming twisted, bent, or otherwise damaged.

While there are technical differences between spools and reels as these terms are used in the art, the term “reel” is used herein to indicate reels and spools used for packaging.

Components used in making reels may include sidewalls and cores, but the structure of the sidewalls and cores may vary greatly. Sidewalls may be formed of wood, plastic, paper or similar materials. Reel cores may be formed of paper, metal or plastic tubes of appropriate diameter and face width which are centered on the sidewalls.

In some cases, holes are punched to accept flat head threaded bolts of a length appropriate to the width of the product that strengthen the reel. The bolt holes are positioned in close proximity to the core, so that when they are tightened, they eliminate, or minimize, rotation of the core. The second sidewall is positioned, and bolts are pressed through both sidewalls, and capped head or “T” nuts are attached to the bolts and tightened, creating a circular package or reel customized to the products width and load area.

These methods of assembly of the sidewalls to the core have heretofore been performed at the place of manufacture of the reels or spools, and not at the place of manufacture of the wound product that is to be contained on reel or spool. The fully assembled reels or spools having no wound product thereon are relatively expensive to ship, leading to inefficiencies. If the empty reels or spools can be shipped as components in an unassembled state, and assembled at the manufacturing site of the wound product, or other place of application of the wound product to the reel or spool, the delivered cost of the reel or spool is reduced.

### SUMMARY OF THE INVENTION

The present invention is an improvement in packaging. The invention may be used with reel or spool packages. It may be used with disposable pallets and other packaging devices.

The reel package of the present invention comprises opposing sidewalls or flanges having interior voids. The sidewalls may be formed of corrugated or similar fluted material, or honeycomb material having pores therein, or similar materials with interior voids.

The sidewalls are connected by a reel core. The reel core may be formed by a partition which acts as a mold, such as a tube that is filled with a flowable material that hardens. The flowable material may be two part expandable polyurethane foam which is applied into the partition by a metering and injection device. The chemistry of the foam formulation may be altered to change density, rigidity and flexibility as required by package stresses. The foam is an effective adhesive medium, which forms the reel core, and connects the sidewalls, to form the reel or spool.

The interior voids of the sidewalls receive the flowable material. The flowable material sets within the geometry of the core and the interior voids, or cells, of the sidewalls, and strengthens the assembled reel. The use of sidewalls having interior voids or cells that are infiltrated with the flowable material is useful for reels requiring high strength.

### DESCRIPTION OF THE DRAWINGS

FIG. 1 is a perspective view of a reel used for packaging.

FIG. 2A demonstrates a die cutter cutting a face of a corrugated sidewall.

FIG. 2B is the sidewall of FIG. 2A after the face is cut to expose an interior of the corrugated sidewall.

FIG. 3 is an exploded view of a reel according to an embodiment the present invention.

FIG. 4 is a sectioned view taken essentially along line 4-4 of FIG. 1.

FIG. 5A demonstrates a die cutter cutting a face of a honeycomb sidewall.

FIG. 5B is the sidewall of FIG. 5A after the facer is cut to expose an interior of the honeycomb sidewall.

FIG. 6 is an exploded view of an embodiment of a reel according to the invention.

FIG. 7 is sectioned view of the reel of FIG. 6, taken essentially along line 7-7 of FIG. 6.

FIG. 8 is a sectioned view of pallet formed according to the invention.

### DESCRIPTION OF THE PREFERRED EMBODIMENTS

Referring to the drawing figures, a reel package according to the present invention comprises sheets of material in the form of opposing sidewalls 2, 4 or flanges which may be formed of corrugated material, which may be corrugated paper, or a material such as honeycomb. The sidewalls may be die cut in a circular configuration by known techniques. The sidewalls are connected by a reel core 6 formed of a flowable material that subsequently sets and hardens. The reel core in this embodiment is formed or molded by preparing a partition 8, which may be an annular ring. The partition may be made of paper or other suitable material, which acts as a mold. The partition receives the flowable material therein, and forms the flowable material.

The flowable material is a liquid or semi-liquid material, which will harden or set to form a reel core. The flowable material may be in the form of foam. The flowable material also acts as adhesive to adhere to the sidewalls and connect the sidewalls to the reel core.

The sidewalls are preferred to be formed of a material having a face, panel or skin on each side of a support structure having voids therein that are referred to a cells. The use of cells that have a face, panel or skin layer on each side yields a generally planar material that is lightweight, but strong. Examples of such materials are corrugated materials, such as corrugated cardboard, and honeycomb materials.

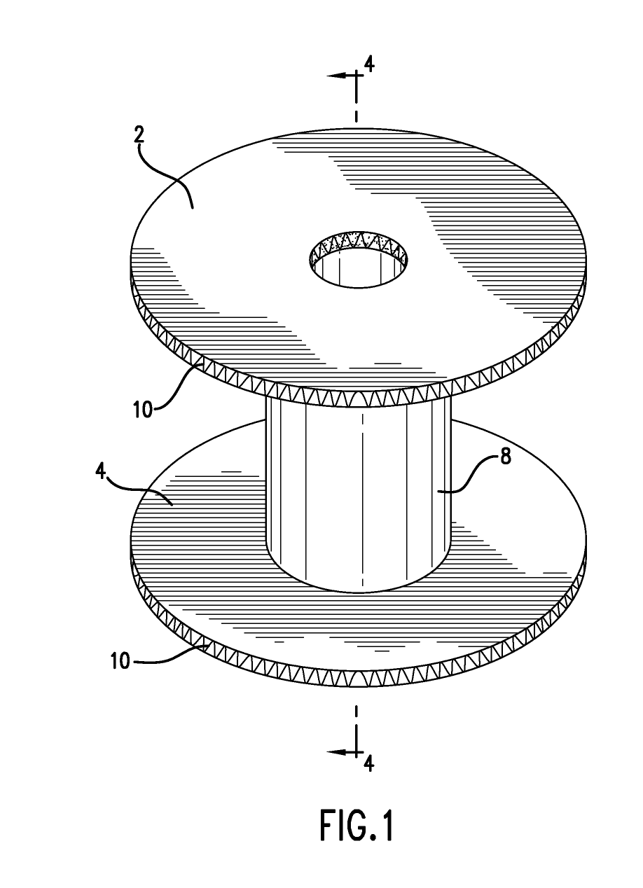

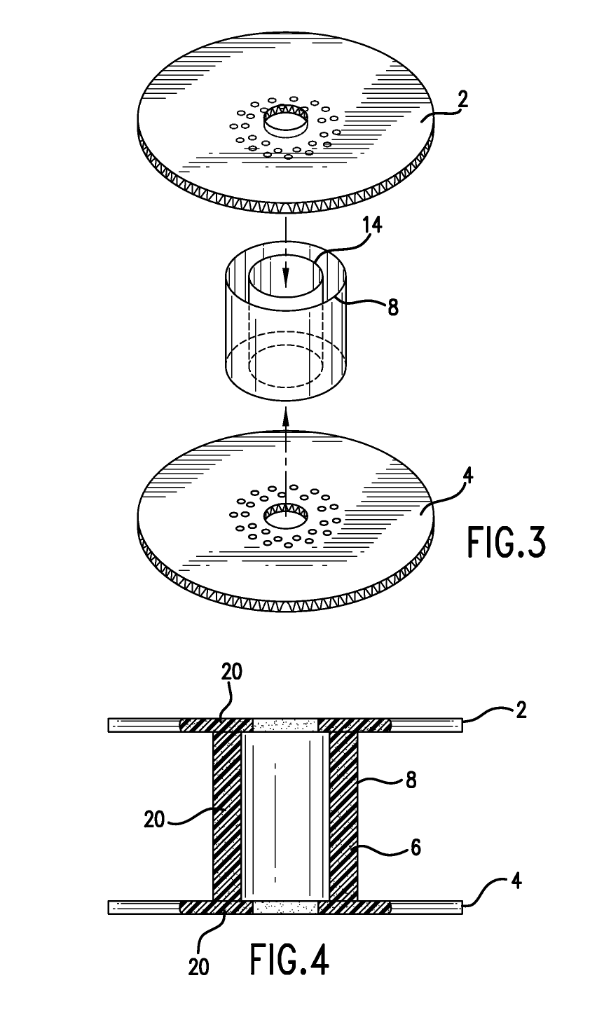

A shown in the embodiment of FIG. 1 through FIG. 4, corrugated or similar material having a flutes 10 or furrows form sidewalls that receive the flowable material. The sidewalls are preferred to have a panel or skin, or a panel or skin on each side of the corrugations. The sidewalls of this embodiment may be formed of corrugated paper or cardboard.

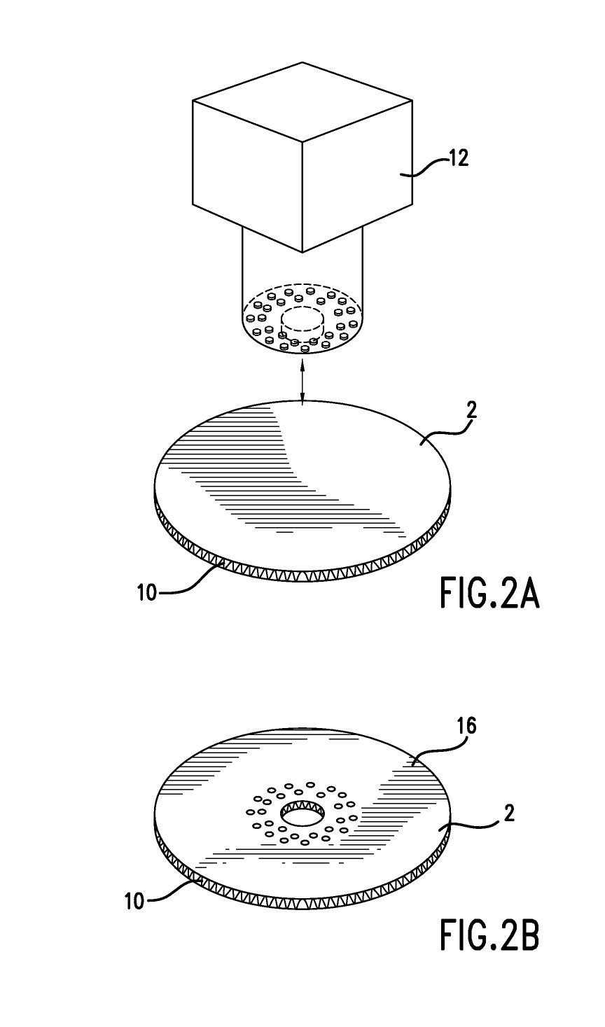

On the face of the sidewall that joins a core, a portion of the panel is removed. A portion of the inner panel 16 may be removed as shown in FIG. 2A and FIG. 2B. A die 12 may be used to perforate the panel or face of the sidewall on an inner surface of the panel. The die cuts or punches holes in the inner panel to reveal the corrugated flutes, or cells 10, of the sidewall. The perforations intersect the core and receive the flowable material and allow it to flow into the cells.

The void is filled with the flowable material 20. As the material expands, it expands into the flutes or similar cells 10 of the sidewalls. When corrugated is used to form the sidewalls, the flowable material flows along the flutes. In most cases, the flowable material will flow along the path of least resistance, which is the longitudinal direction of the voids in the flutes. The flowable material will not tend to flow across the flutes. This is demonstrated by FIG. 4, which is a cross section taken to show the flow of the flowable material along the flutes for a distance. The flowable material flows past the intersection of the sidewall with the core. As the material hardens, it adheres to the sidewalls, but further, the hardened material provides a strong mechanical connection that is more than an adhesive connection, due to its presence in the flutes. In the embodiment shown in the drawings, the flowable material forms a single structure that connects the core and both sidewalls, as the flowable material hardens, since it extends from the interior of one sidewall, to the core and to the interior of the second sidewall. This mechanical connection goes beyond adhesion, and adds strength to the resulting reel or spool. It is not necessary or practical that the flowable material entirely fills the flutes of the sidewalls. Some flow of the flowable material into the flutes adds strength to reel and superior attachment of the sidewalls. This structure is particularly effective in preventing the sidewall from shearing from the core.

The flowable material may be comprised of two-part expandable polyurethane foam. Polyurethanes may be formed by isocyanates, which are reacted with agents having a hydroxyl group, such as polyols. These materials may be produced as foam which expands as it is dispensed. The foam is delivered into a defined void in a metered dosage. The foam fills the void, and the reaction of the components causes the foam to set and become solid in the shape of the void. The chemistry of the foam formulation may be altered to change density, rigidity and flexibility as required by package stresses. The expanded foam is a very aggressive and effective adhesive medium that enters the flutes of the corrugated material. As the foam cures it adheres to each of the sidewalls, it performs the dual function of forming the reel core and connecting the sidewalls to form the completed reel, and no other mechanical fasteners are usually required.

A partition accepts the foam therein and molds the foam to form the reel core. A preferred material for the partition is an annular ring formed of paper. A paper ring is easily and inexpensively formed. The foam is applied into the paper ring by an injection device, which meters the foam to be injected. Upon injection into paper ring, the wet foam bonds to the sidewalls. The foam reacts and hardens to form the reel core after an exothermic reaction of short duration. Normally, it is unnecessary to remove the paper ring after the foam sets.

Sidewall 2 may be positioned in an assembly fixture. A paper ring 6 of appropriate width and diameter is positioned and mechanically centered on the sidewall by position guides. A controlled amount of the specially formulated two part expandable polyurethane foam may be injected into to the void or space that is present between by the outer partition 8 and an inner ring 14. The second or top sidewall 4 may be positioned as the foam begins to expand and fill the void, which becomes a closed compartment created by the positioning of the second sidewall or flange. A barrier may be provided as part of the assembly fixture to prevent the foam from escaping from flutes that intersect the center void of the sidewalls if the sidewalls have a center void as shown in the drawings.

The foam or flowable material expands to the limits of the compartment or void formed by the paper ring. The flowable material foam bonds the sidewalls to form a single, rigid, lightweight package of a size and strength required for the application.

For reels or packages which require large diameter reel cores and wide separation of the sidewalls or flanges, the amount of foam used can be reduced by a second ring 14 of a smaller diameter. The second ring is usually placed concentrically with the first ring. A compartment is formed between the top and bottom sidewalls and the two rings into which the foam is dispensed. Chemical variation of the foam mix, such as the density, allows the strength characteristics to be adjusted to compensate for the reduced area of adhesion. The use of two rings to create a compartment reduces the amount of polyurethane used to fill a void and create a bond. Other shaped materials may also be effective in partitioning a void, or occupying space in the void, to achieve similar results. For reels with relatively small reel cores only a single paper ring of appropriate diameter may be used. An assembly fixture with the commercially available foam injection device assists in assembly and bonding.

Since polyurethane foam is a highly effective bonding agent, plastic spools which require solvent bonding and complex tooling intended impart strength and gain dimensional integrity of the reel or spool are unnecessary. The use of simplified flanges bonded according to the present invention is an effective replacement. The elimination of harmful solvents is considered a benefit to the safety of the work place. The urethane foam is a safe bonding agent, and has an enviable record in industrial applications.

The sidewalls may be formed of multiple layers or plies. The multiple layers may be of the same material, or of different materials. The multiple layers may be connected by an adhesive.

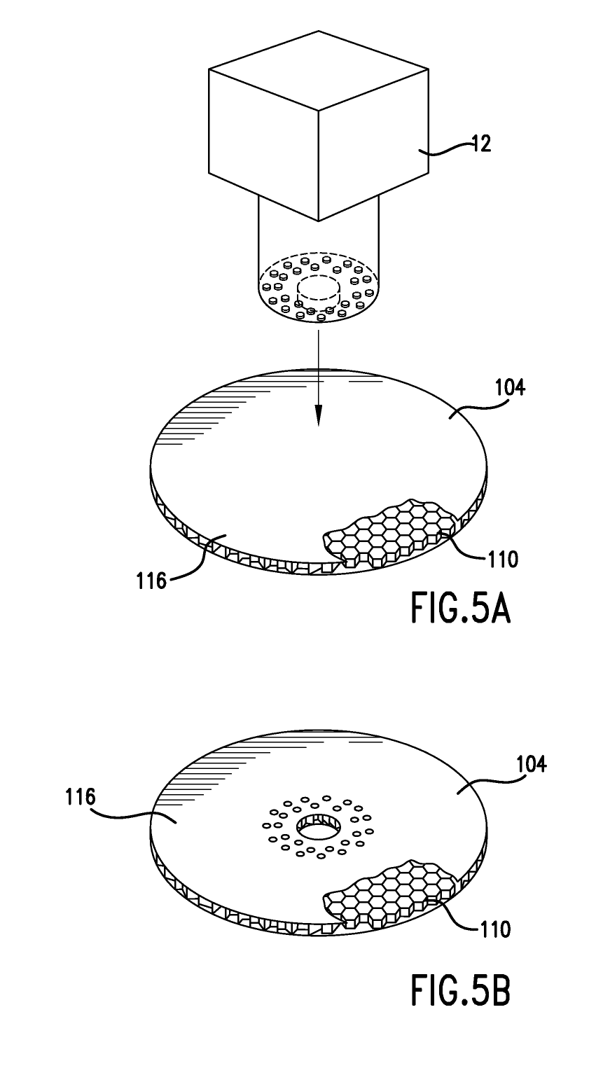

As shown in FIGS. 5 and 5B, the sidewalls are formed of honeycomb material. The cells are pores, which may be hexagonally shaped and connected to each other in a honeycomb fashion. The cells receive a flowable material that preferably expands and adheres the core and sidewalls to form the reel or spool. The sidewalls are preferred to be formed of a material having a face, panel or skin on each side of a support structure having voids therein that are referred to a cells.

A shown in the embodiment of FIG. 5 through FIG. 7, honeycomb or similar material having pores as cells 110 or furrows form sidewalls 102, 104 that receive the flowable material. The sidewalls are preferred to have a panel 116 or skin, or a panel or skin on each side of the corrugations. The sidewalls of this embodiment may be formed of paper or cardboard having cells.

On the face of the sidewall that joins a core, a portion of the panel is removed. A portion of the inner panel 116 may be removed as shown in FIG. 5A and FIG. 5B. A die 12 may be used to perforate the panel or face of the sidewall on an inner surface of the panel. The die cuts or punches holes in the inner panel to reveal the cells 110 of the honeycomb structure of the sidewall. The perforations intersect the core and receive the flowable material and allow the flowable material to flow into the cells.

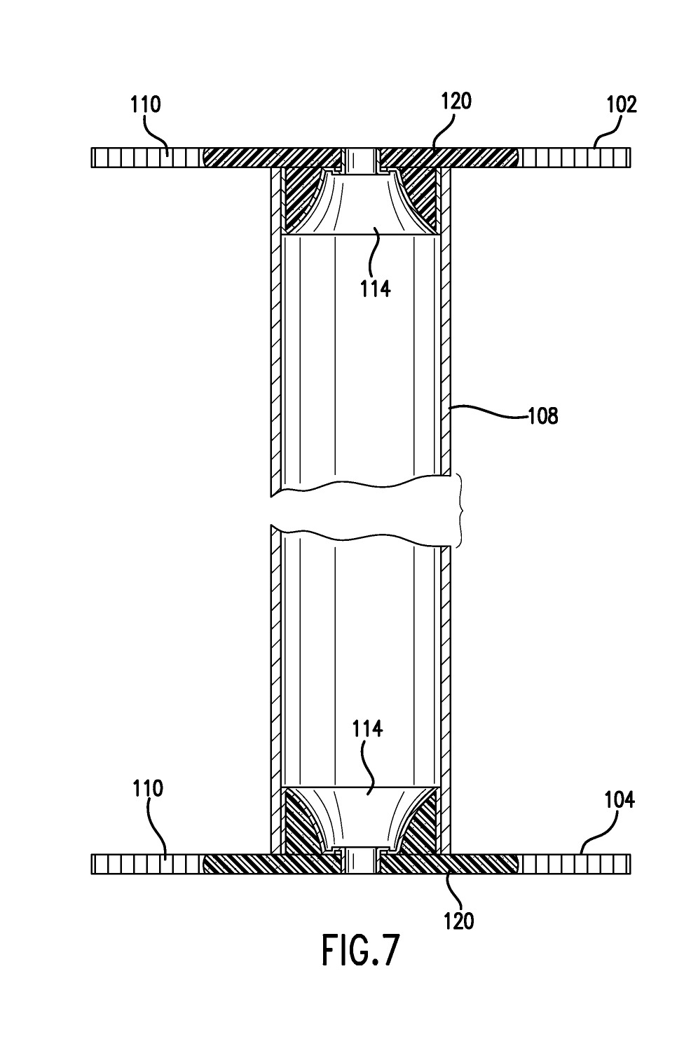

The void is filled with the flowable material 120. As the material expands, it expands into the pores or similar cells 110 of the sidewalls. When honeycomb material is used to form the sidewalls, the flowable material fills the cells. The flowable material is under pressure. The pressure tends to break down the walls of the cells and flow into adjoining cells. This is demonstrated by FIG. 7, which is a cross section taken to show the flow of the flowable material across cells. The flowable material passes into the cells through the perforations in the sidewalls, and flows into cells that do not intersect the perorations, as the pressure of the expanding flowable material breaks down the walls of the cells until the quantity and pressure of the flowable material is insufficient to break down the walls of the cells. As shown in FIG. 7, the flowable material flows past the intersection of the sidewall with the core. As the material hardens, it adheres to the sidewalls. Further, the hardened material provides a strong mechanical connection that is more than an adhesive connection, due to its presence in the cells.

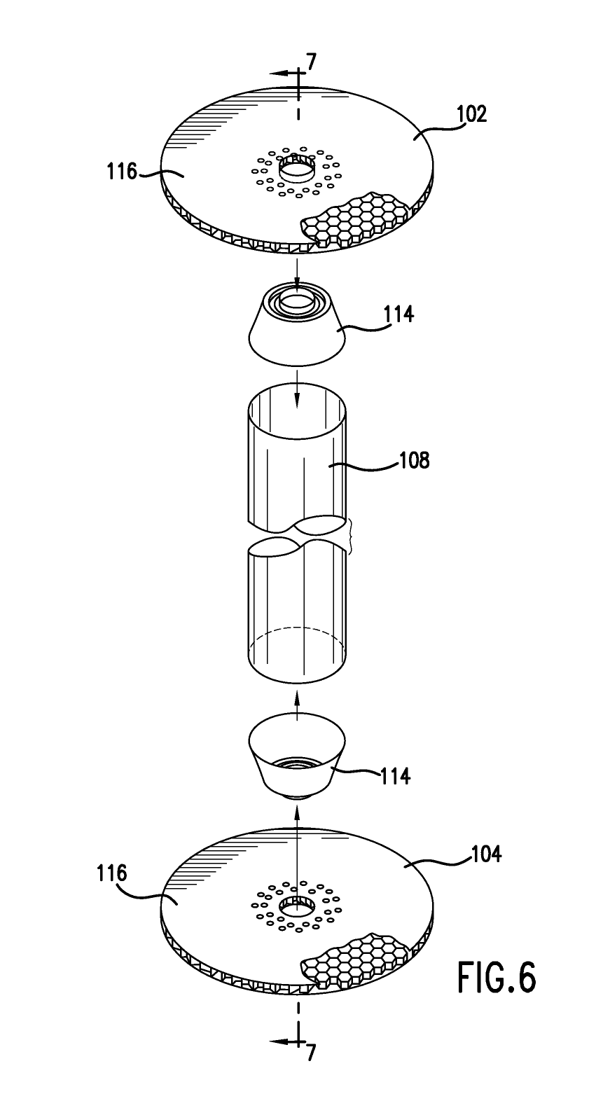

In the embodiment shown in FIG. 6 and FIG. 7, inserts 114 are used. The inserts reduce the amount of flowable material that is required to adhere and connect the sidewalls to the core to form the reel. The inserts control the flow of flowable material within the core, and force the flowable material into the cells of the sidewalls. The flowable material connects the core to a sidewall, as the flowable material hardens, since it extends from core and into the interior of each sidewall. This mechanical connection goes beyond adhesion, and adds strength to the resulting reel or spool. It is not necessary or practical that the flowable material entirely fills the flutes of the sidewalls. Some flow of the flowable material into the flutes adds strength to reel and superior attachment of the sidewalls. This structure is particularly effective in preventing the sidewall from shearing from the core. Inserts of similar structure can be used with corrugated sidewalls and other sidewalls having cells that receive flowable material.

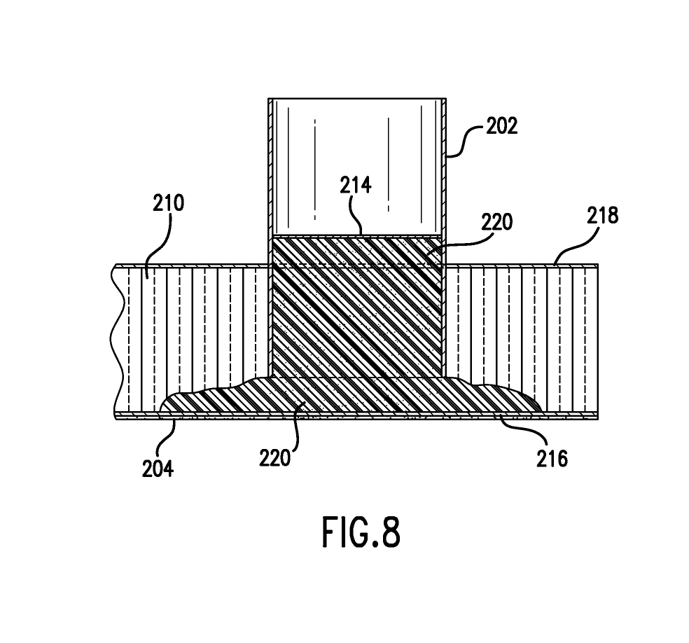

The invention may be used to form structures other than reels or spools. Other devices that are formed by joining a first element that has, or is capable of having, a void, to a second element having cells may be constructed using the invention. An embodiment of a pallet is shown in FIG. 8. The pallet is inverted as shown in the drawing. The pallet has a core that forms a foot 202, and also a deck or base 204. The partition for the core may be formed of plastic or a paper spool that will support the required load. The partition comprises a container, which may be a bore surrounded by plastic or paper or similar materials. A barrier 214 may be used to reduce the size of the container into which flowable material 220 is placed and to direct the flowable material into the cells of the base. The pallet may be formed of a material having panels 216, 218 that sandwich a plurality of cells 210. The material may be honeycomb or corrugated material having cells.

In one embodiment, a die is used to cut through layer or panel 218 of a material that may be 2.5 cm. thick in one embodiment. The die forms an opening for the core or foot, and compresses the cells to the bottom of the opening. The die of this embodiment compresses rather than cuts the cells to form the opening, although some of the cells could be cut. The layer or panel 216 is not cut. The core or foot is inserted into the opening. Expandable flowable material is placed into the bore of the foot or core. Barrier 214 is promptly positioned to force the flowable material into contact with the compressed cells as the flowable material expands. As the flowable material cures, it bonds to the core or foot and to the compressed cells, connecting the core or foot and the deck or base. Depending on dosage, the flowable material may push beyond the compressed cells and away from the core or foot. The hardened material provides a strong mechanical connection that is more than an adhesive connection, due to its presence in the cells.

Multiple feet can be used as desired or required. The top of the base or deck may be joined, such as by adhesive, to additional layers of honeycomb or corrugated or other materials to improve strength of the pallet. In one embodiment, the top of the deck is relatively small (15 cm. by 15 cm., for example) and the process is used to form legs that are attached to larger sheets of material to form disposable pallets.

What is claimed is:

1. A packaging device, comprising:
a) a first sheet of material comprising a panel and a plurality of cells, wherein an aperture is present in said panel; and
b) a core formed of a flowable and expandable material that sets and connects said sheet of material to said core, wherein said flowable and expandable material extends from an exterior of said sheet of material and through said aperture of said panel and into said plurality of cells.

2. A packaging device as described in claim 1, wherein said first sheet of material is corrugated material, and wherein said plurality of cells are longitudinal flutes, and wherein said flowable and expandable material is present in said longitudinal flutes.

3. A packaging device as described in claim 1, wherein said first sheet of material is honeycomb material, and wherein said plurality of cells are pores that adjoin other pores, and wherein said flowable and expandable material is present in said pores.

4. A packaging device as described in claim 1, wherein said first sheet of material is honeycomb material, and wherein said cells are pores that adjoin other pores, and wherein said flowable and expandable material is present in said pores, and said flowable and expandable material flows to break down walls of said cells and enter said other pores that adjoin said cells and said flowable and expandable material is present in said other pores.

5. A packaging device as described in claim 1, wherein said first sheet of material comprises a second panel that is opposite said panel, and wherein said plurality of cells are disposed between said panel and said second panel.

6. A packaging device as described in claim 1, further comprising a second sheet of material that is opposite said sheet of material, said second sheet of material comprising a panel and a plurality of cells, wherein an aperture is present in said panel of said second sheet of material, and said core formed of a flowable and expandable material sets and connects said second sheet of material to said core and said first sheet of material to said core, wherein said flowable and expandable material extends from an exterior of said second sheet of material through said aperture of said panel and into said plurality of cells of said second sheet of material.

7. A packaging device as described in claim 1, wherein said packaging device is a reel.

8. A packaging device as described in claim 1, further comprising a partition having an interior void that communicates with said aperture of said panel of said first sheet of material, and wherein said flowable and expandable material is placed into said interior void to form said core, and said flowable and expandable material enters said aperture and said plurality of cells from said interior void of said partition.

9. A packaging device as described in claim 1, wherein said panel further comprises a plurality of apertures in said panel and wherein said flowable and expandable material extends from an exterior of said sheet of material through said plurality of apertures of said panel and into said plurality of cells.

10. A method of producing a packaging device, comprising the steps of:
a) forming a first sheet of material in a desired configuration, said first sheet of material comprising a panel and a plurality of cells, wherein said panel comprises an aperture;
b) placing a partition having an interior void adjacent to said panel, wherein said interior void is adjacent to said aperture;
c) placing said flowable and expandable material in said interior void of said partition, wherein said flowable and expandable material flows from said interior void through said aperture and into said plurality of cells;
d) allowing said flowable and expandable material to cure, wherein said flowable and expandable material forms a solid core, and joins said solid core to said first sheet of material.

11. A method of producing a packaging device as described in claim 10, wherein said first sheet of material comprises a second panel that is opposite said panel, and wherein said plurality of cells are disposed between said panel and said second panel.

12. A method of producing a packaging device as described in claim 10, wherein said aperture is formed by die cutting.

13. A method of producing a packaging device as described in claim 10, further comprising the steps of
a) forming a second sheet of material in a desired configuration, said second sheet of material comprising a panel and a plurality of cells, wherein said panel comprises an aperture;
b) placing said partition having an interior void adjacent to said panel of said second sheet of material, wherein said interior void is adjacent to said aperture of said second sheet of material;
c) causing said flowable and expandable material to flow from said interior void through said aperture and into said plurality of cells of said second sheet of material;
wherein when said flowable and expandable material cures, said solid core joins said first sheet of material and said second sheet of material.

14. A packaging device as described in claim 10, wherein said panel further comprises a plurality of apertures and wherein said flowable and expandable material flows from an exterior of said sheet of material through said plurality of apertures of said panel and into said plurality of cells.

15. A method of producing a packaging device as described in claim 10, further comprising the steps of placing a second partition within said outside perimeter of said partition, and filling a void that is present between said outside perimeter of said partition and an outside perimeter of said second partition with said flowable and expandable material.

16. A method of producing a packaging device as described in claim 10, wherein said first sheet of material is generally circular and is generally concentric with said partition, and wherein said outside perimeter of said partition is generally circular.

17. A packaging device as described in claim 10, wherein said first sheet of material is corrugated material, and wherein said plurality of cells are longitudinal flutes, and wherein said flowable and expandable material flows longitudinally within said longitudinal flutes as said flowable and expandable material expands and flows.

18. A packaging device as described in claim 10, wherein said first sheet of material is honeycomb material, and wherein said plurality of cells are pores that adjoin other pores, and wherein said flowable and expandable material flows into said pores as said flowable and expandable material expands and flows.

19. A packaging device as described in claim 10, wherein said first sheet of material is honeycomb material, and wherein said cells are pores that adjoin other pores, and wherein said flowable and expandable material is present in said pores, and said flowable and expandable material flows to break down walls of said pores and enter said other pores that adjoin said cells as said flowable and expandable material expands and flows.

20. A packaging device as described in claim 1, wherein said flowable and expandable material comprises polyurethane foam.

21. A method of producing a packaging device as described in claim 10, wherein said flowable and expandable material comprises polyurethane foam.

22. The packaging device produced by the method of claim 10.

23. The packaging device produced by the method of claim 11.

24. The packaging device produced by the method of claim 12.

25. The packaging device produced by the method of claim 13.

26. The packaging device produced by the method of claim 14.

27. The packaging device produced by the method of claim 15.

28. The packaging device produced by the method of claim 16.

29. The packaging device produced by the method of claim 17.

30. The packaging device produced by the method of claim 18.

31. The packaging device produced by the method of claim 19.

32. The packaging device produced by the method of claim 21.
